(19) United States
(12) Patent Application Publication
(10) Pub. No.: US 2004/0214052 A1
(43) Pub. Date: Oct. 28, 2004

(54) Color-coded battery storage system

(76) Inventor: Donald R. Rochelo, Pittsfield, MA (US)

Correspondence Address: MALCOLM J. CHISHOLM, JR., ATTORNEY AT LAW, P. O. BOX 278, 220 MAIN STREET, LEE, MA, 01238, US

(21) Appl. No.: 10/832,632

(22) Filed: Apr. 27, 2004

Related U.S. Application Data
(60) Provisional application No. 60/465,916, filed on Apr. 28, 2003.

(51) Int. Cl. H01M 2/10; H01M 10/42; B65D 85/00

(52) U.S. Cl. 429/9; 429/99; 429/49; 206/703

(57) ABSTRACT

A color-coded battery storage system (10) for conveniently storing dry-cell batteries includes two or more battery containing packs (12, 32), wherein each pack has a rigid exterior shell (14, 34), all or a portion of which is light transmitting to permit observation of a color of a resilient insert (24, 42) within the pack. A first resilient insert (24) of a first pack (14) defines first cavities (26) that are dimensioned to receive and secure first size batteries (28), and the first insert (24) is also color-coded within the battery system to be associated exclusively with the first size batteries (26). A second pack (32) defines second cavities (44) dimensioned to receive and secure second size batteries (46), and the second cavities (44) are color-coded to be exclusively associated with the second size batteries (46) to facilitate identification and protection of stored batteries.

### CROSS REFERENCE TO RELATED APPLICATION

This Application claims the benefit of U.S. Provisional Patent Application Serial No. 60/465,916 that was filed on Apr. 28, 2003, entitled “Color-Coded Battery Storage System”.

### TECHNICAL FIELD

The present invention relates to a battery storage system for safely storing and quickly identifying dry cell batteries, such as batteries used in consumer electronics, flashlights, cameras, etc.

### BACKGROUND ART

Dry cell batteries are well known for providing a source of electrical current for common, household items such as flashlights, portable audio tape and compact disc players, cameras, etc., and it is well known that such dry cell batteries are available in common sizes and voltages. Ordinary battery size designations include “C”, “D”, “AA”, “AAA” size batteries, and with the advent of digital cameras growing in popularity, “lithium batteries” are increasingly available in size designations including for example “CR2” and “123” size designations. Also, more costly rechargeable batteries are common in the same sizes. It is common for a modern household to acquire on a regular basis varying sizes of dry-cell batteries for varying household items.

Typically, such batteries are sold in a light transmitting, see-through package that houses two to twelve of the batteries in a cluster that is efficiently prepared for retail display in stores. However, once a user opens such a package and extracts some of the batteries, the package is no longer an efficient storage device because batteries may move about and fall out of the package to be lost, and it is difficult to know how many batteries remain within such opened retail display packages. Frequently therefore, a user will extract the batteries for storage in a separate, more secure container. Such a practice almost always includes adding batteries of varying sizes to such a separate battery container. For example, it is increasingly common that a household will have a supply of single use and rechargeable “AA” and “AAA” sized batteries stored together within a single container. Additionally, the increasing popularity and declining cost of modern cameras has produced a common practice of storing one or more cameras of substantial value in convenient, portable “shoulder-strap” types of non-rigid containers along with a supply of varying kinds of film, and the necessary batteries to operate the lighting and film advancing requirements of the cameras. Such a camera container is invariably taken along on travels of household members, and it is critical that the user not run out of necessary batteries. Consequently it is common to store varying sized batteries within a common container for such purposes.

Problems of such a battery storage arrangement include an inability to know exactly how many fresh batteries of particular sizes are available. For example, a user may glance into the battery storage container and conclude there is an adequate supply of “AAA” sized batteries, only to find out during a recreational journey or photographic undertaking at a remote site that what the user thought were “AAA” batteries are actually “AA” sized batteries, or that “CR2” lithium batteries are actually “123” lithium batteries. A further problem is that batteries loosely stored may accidentally contact conductive materials, such as moisture or water within a cloth component of the container, conductive metals or metal foils, and thereby discharge. Such circumstances not only result in a loss of the electrical current of the battery, but in some conditions may present a fire hazard through accidental battery discharge.

Accordingly, there is a need for a battery storage system that provides an efficient, safe, electrical-discharge proof case that isolates the batteries from accidental contact with each other and with conductive materials; that allows a user to quickly identify the size and number of batteries stored within the case; and, that is easy and safe to carry within a user's shirt pocket.

### SUMMARY OF THE INVENTION

The invention is a color-coded battery storage system for conveniently storing dry-cell batteries. The system includes two-or-more battery containing packs, wherein each pack includes a rigid exterior shell, all or a portion of which is light transmitting to permit observation of a color of a resilient insert within the pack. A first resilient insert of a first pack is secured within a first rigid shell, and the first insert defines a plurality of first cavities that are dimensioned to receive and secure batteries of a first battery size. The first resilient insert of the first pack is also a distinctive color, such as a first color that is color-coded within the battery system to be associated exclusively with the first size batteries. For example, the first pack may have a resilient insert made of a yellow rubber-like material that defines a plurality of first cavities dimensioned to receive and secure batteries designated as “AA” size.

A second battery containing pack includes a second rigid exterior shell that may be identical to the first rigid exterior shell of the first pack. However, a second resilient insert defines a plurality of second cavities that are dimensioned to receive and secure batteries of a second battery size that is distinct from the first battery size, and the second resilient insert is made of a second distinctive color that is distinct from the first color and that is color-coded to be associated exclusively with the second battery size cavities. For example, the second resilient insert may be made of a green rubber-like material that defines cavities dimensioned to receive batteries designated as “AAA” size.

The battery storage system may include additional packs having, for example, a third battery containing pack including a third resilient insert defining a plurality of third cavities dimensioned to receive and secure batteries of a third battery 'size, for example a “123” battery size. The third insert may be made of a third distinctive color that is color-coded for the third, or “123” battery size, such as the third insert being made of an orange rubber-like material. Additionally, a fourth battery containing pack may also be included having a fourth resilient insert defining a plurality of fourth cavities dimensioned to receive batteries of a fourth battery size, such as a “CR2” battery size. As with the first, second and third inserts, the fourth insert may be made of a fourth distinctive color that is color-coded for the fourth, or “CR2” battery size, such as the fourth insert being made of a purple rubber-like material. Further packs with distinctive colored inserts associated with distinctive size cavities may also be part of the color-coded battery storage system.

The rigid exterior shells of the battery packs include a securing latch or latches to permit closing of the shell to secure the resilient inserts within containment chambers defined by the shells. When a shell is closed, the shell also serves to further secure the batteries within the cavities of the inserts against movement out of the cavities so that the batteries cannot contact each other. The rigid shell is all or partially light transmitting to permit a user to rapidly identify by the distinctive color of the insert within the shell the specific battery size being stored within the container, and to rapidly determine the number of batteries being stored within the pack.

The rigid shell and resilient insert may be cooperatively dimensioned to also include a fluid seal restricting arrangement such as a peripheral edge of a securing shell half defining a compression ridge that contacts and compresses a peripheral edge of the resilient insert so that a liquid fluid contaminant cannot enter the containment chamber of the case when the rigid shell is closed. Because the rigid shells of the color-coded battery storage system may be identical for each of a plurality (meaning two or more) of the battery containing packs having varying resilient inserts, manufacturing efficiencies may be realized. The system enables manufacture of a common rigid shell that may receive and secure various resilient inserts.

Accordingly, it is a general purpose of the present invention to provide a color-coded battery storage system that overcomes deficiencies of the prior art.

It is a more specific purpose to provide a color-coded battery storage system that provides secure storage of dry-cell batteries protecting the batteries against accidental loss and discharge.

It is yet another purpose to provide a color-coded battery storage system that enables a user to quickly identify the quantity and size of batteries stored within the system.

These and other purposes and advantages of the present color-coded battery storage system will become more readily apparent when the following description is read in conjunction with the accompanying drawing.

### BRIEF DESCRIPTION OF THE DRAWINGS

FIG. 1 is an expanded, perspective view of a first battery containing pack constructed in accordance with the present color-coded battery storage system.

FIG. 2 is an expanded, perspective view of a second battery containing pack constructed in accordance with the present color-coded battery storage system.

FIG. 3 is an expanded, perspective view of a third battery containing pack constructed in accordance with the present color-coded battery storage system.

FIG. 4 is an expanded, perspective view of a fourth battery containing pack constructed in accordance with the present color-coded battery storage system.

FIG. 5 is a perspective view of a fifth battery containing pack showing cavities defined within the pack dimensioned to receive and secure batteries and memory storage devices, constructed in accordance with the present color-coded battery storage system.

FIG. 6 is a perspective view of a resilient insert dimensioned to be secured within the FIG. 5 fifth battery containing pack showing cavities defined within the insert dimensioned to receive and secure batteries and memory storage devices.

### DESCRIPTION OF THE PREFERRED EMBODIMENTS

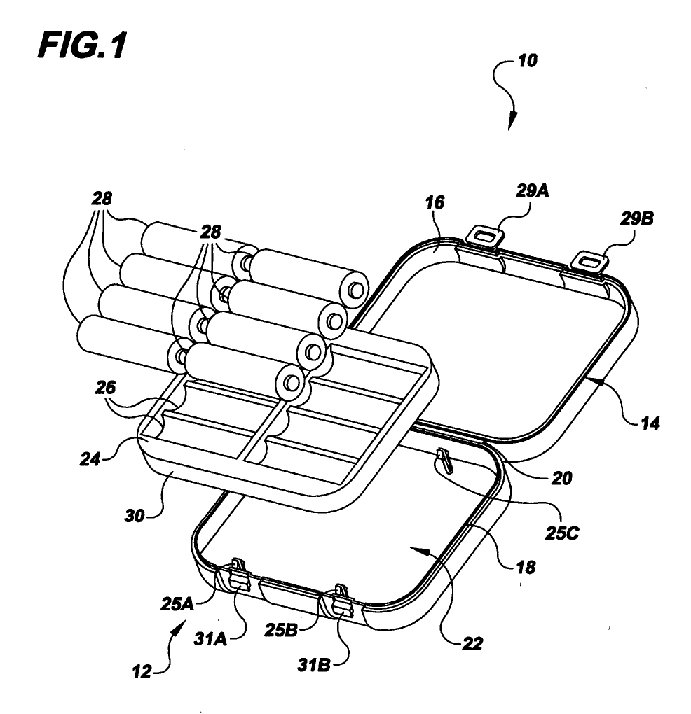

Referring to the drawings in detail, a color-coded battery storage system is shown in FIG. 1, and is generally designated by the reference numeral 10. The system 10 includes a plurality of battery containing packs, wherein a first pack 12 is shown in FIG. 1. The first pack 12 includes a first light transmitting, rigid, exterior shell 14, which includes a first securing half shell 16 and a first receiving half shell 18. The securing and receiving half shells 16, 18 are cooperatively dimensioned to be secured together, such as by a hinge 20, or any other securing means for permitting the half shells 16, 18 to be open, as shown in FIG. 1, or closed, wherein a first containment chamber 22 is defined between the securing half shell 16 and receiving half shell 18. For purposes herein, the phrase “light transmitting” as applied to the rigid exterior shell 14 and other shells described herein is to mean that adequate light is transmitted through the shell 14 to permit a user to detect a color within the first containment chamber 22. This may be achieved by having a small portion of the entire shell 14 be light transmitting, or by having the entire shell 14 be light transmitting.

A first resilient insert 24 is dimensioned to be secured within the receiving half shell 18, and the first resilient insert 24 defines a plurality of first cavities 26, wherein each cavity is dimensioned to receive and secure a first size battery 28, such as a plurality of “AA” size batteries 28, as shown in FIG. 1. The first receiving half shell 18 may also include a plurality of securing posts 25A, 25B, 25C projecting into the first containment chamber 22 and dimensioned to be received in a corresponding plurality of securing slots (not shown) defined within the first resilient insert 24 to assist in securing the insert 24 within the containment chamber 22. The first rigid shell 14, and other rigid shells described herein, also include latch means for fastening the securing shell half 16 and the receiving shell half 18 together in a closed position to thereby secure the first size batteries 28 within the first cavities 26. The latch means may include any latching mechanism known in the art, such as one or more first latches 29A, 29B, positioned on the securing shell half 16 to hinge over and secure to corresponding latch receivers 31A, 31B positioned on the first receiving shell half 18 in a manner well known in the art.

The first resilient insert 24 is also made of or includes a first distinctive color 30 that is color-coded to be associated exclusively with the first battery size batteries 28, so that the first insert color 30 may be observed through the first shell 14. The first resilient insert 28, and other resilient inserts described herein; may be made of any deformable material, such as soft, elastic or rubbery material known in the art to cushion objects against a shock of accidental impact. An exemplary material for the first resilient insert 24 is a blend of polypropylene and kraton rubber, including a resin sold under the trade name “DYNAFLEX”, of the GLS Corporation, on McHenry, Ill. 60050, U.S.A.

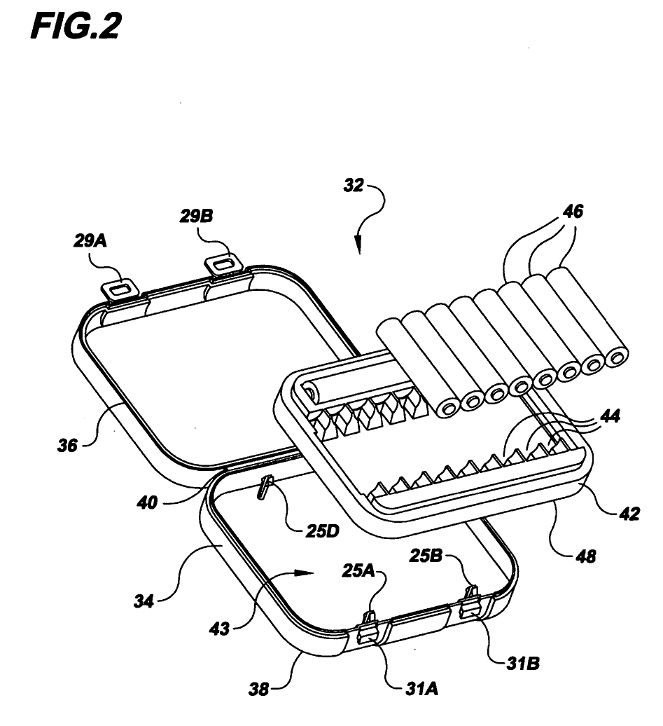

As shown in FIG. 2, a second battery containing pack 32 includes a second light transmitting, rigid exterior shell 34 which may be identical to the first shell 14, and includes a second securing half shell 36 and a second receiving half shell 38 that may be secured by hinge 40 for closing as described above. A second resilient insert 42 is dimensioned to be secured within the second receiving half shell 38, and the second resilient insert 42 defines a plurality of second cavities 44 that are dimensioned to receive and secure batteries 46 of a second size, such as an “AAA” battery size as shown in FIG. 2. The second resilient insert is also made of or includes a second distinctive color 48 that is distinct from the first insert color 30, and that is color-coded to be associated exclusively with the second size batteries 46, so that the second insert color 48 may be observed through the second shell 34. As described above, the second resilient insert 42, and other resilient inserts described herein, may also be secured within the second receiving half shell 38 by the plurality of securing posts 25A, 25B, 25D. Additionally, the second rigid shell 34 may include securing means described above for securing the second securing shell half 36 to the second receiving shell half 38, such as the described latches 29A, 29B, and latch receivers 31A, 31B.

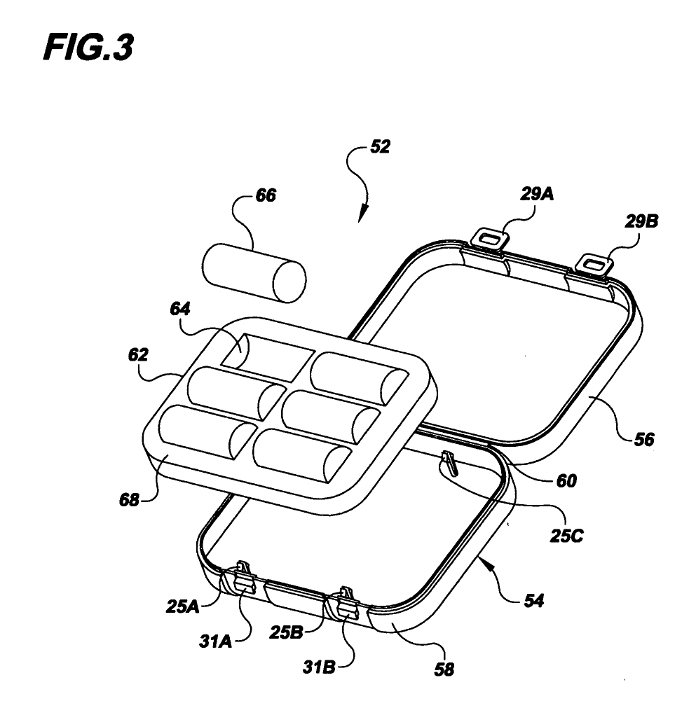

FIG. 3 shows a third battery containing pack 52, that includes a third light transmitting, rigid exterior shell 54 which may be identical to the first shell 14, and includes a third securing half shell 56 and a third receiving half shell 58 that may be secured by hinge 60 for closing as described above. A third resilient insert 62 is dimensioned to be secured within the third receiving half shell 58, and the third resilient insert 62 defines a plurality of third cavities 64 that are dimensioned to receive and secure batteries 66 of a third size, such as a “123” battery size as shown in FIG. 3. The third resilient insert is also made of or includes a third distinctive color 68 that is color-coded to be distinct from the first insert color 30 and second insert color 48, and to be associated exclusively with the third size batteries 66, so that the third insert color 68 may be observed through the third shell 54.

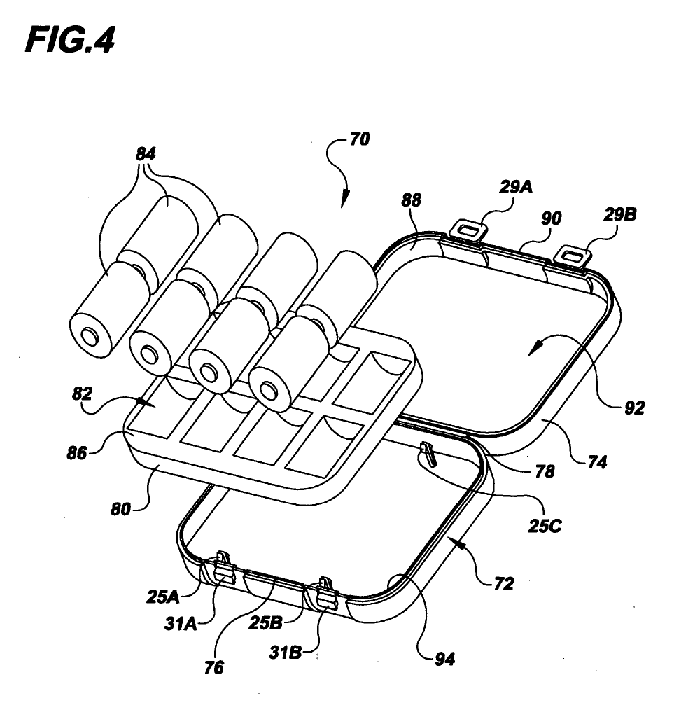

FIG. 4 shows a fourth battery containing pack 70, that includes a fourth light transmitting, rigid exterior shell 72 which may be identical to the first shell 14, and includes a fourth securing half shell 74 and a fourth receiving half shell 76 that may be secured by hinge 78 for closing as described above. A fourth resilient insert 80 is dimensioned to be secured within the fourth receiving half shell 76, and the fourth resilient insert 80 defines a plurality of fourth cavities 82 that are dimensioned to receive and secure batteries 84 of a fourth size, such as a “CR2” battery size as shown in FIG. 4. The fourth resilient insert is also made of or includes a fourth distinctive color 86 that is color-coded to be distinct from the first insert color 30, second insert color 48 and third insert color 68, and to be associated exclusively with the fourth size batteries 66 so that the fourth insert color 86 may be observed through the fourth shell 72.

All of the rigid shells herein, such as 14, 34, 54 and 72 may be cooperatively dimensioned with the resilient inserts 24, 42, 62 and 80 to include a fluid seal means for restricting movement of fluids into contact with the inserts 24, 42, 62 and 80 whenever the shells 14, 34, 54 and 72 are closed. Such fluid seal means may be any structures known in the art for restricting fluid movement between secured half shells or similar structures when closed. For example, and as shown in FIG. 4, a peripheral edge 88 of the fourth securing half shell 74 may include a compression ridge 90 that is dimensioned to extend into a containment chamber 92 defined between the fourth securing half shell 74 and the fourth receiving half shell 76. The fourth resilient insert 80 is also dimensioned to extend adjacent to or above a peripheral edge 94 of the fourth receiving half shell 76, so that whenever the fourth shell 72 is closed, the compression ridge 90 compresses the fourth resilient insert 80 to create a fluid seal, protecting any fourth sized batteries 84 stored within the fourth pack 70.

To further enhance the fluid seal means, the rigid shells 14, 34, 54 and 72 may include the described latch means, wherein at least two latches 29A, 29B and corresponding latch receivers 31A, 31B are utilized in order to apply a more uniform pressure between the described securing and receiving half shells. For example, as shown in FIG. 4, the first latch 29A and second latch 29B may be secured to the peripheral edge 88 of the fourth securing half shell 74 to correspond to the first latch receiver 31A and second latch receiver 31B secured to the peripheral edge 94 of the fourth receiving half shell 76. Such a plurality of latches 29A, 29B and latch receivers 31A, 31B applies uniform pressure to the closed half shells 74, 76 to enhance the fluid seal means.

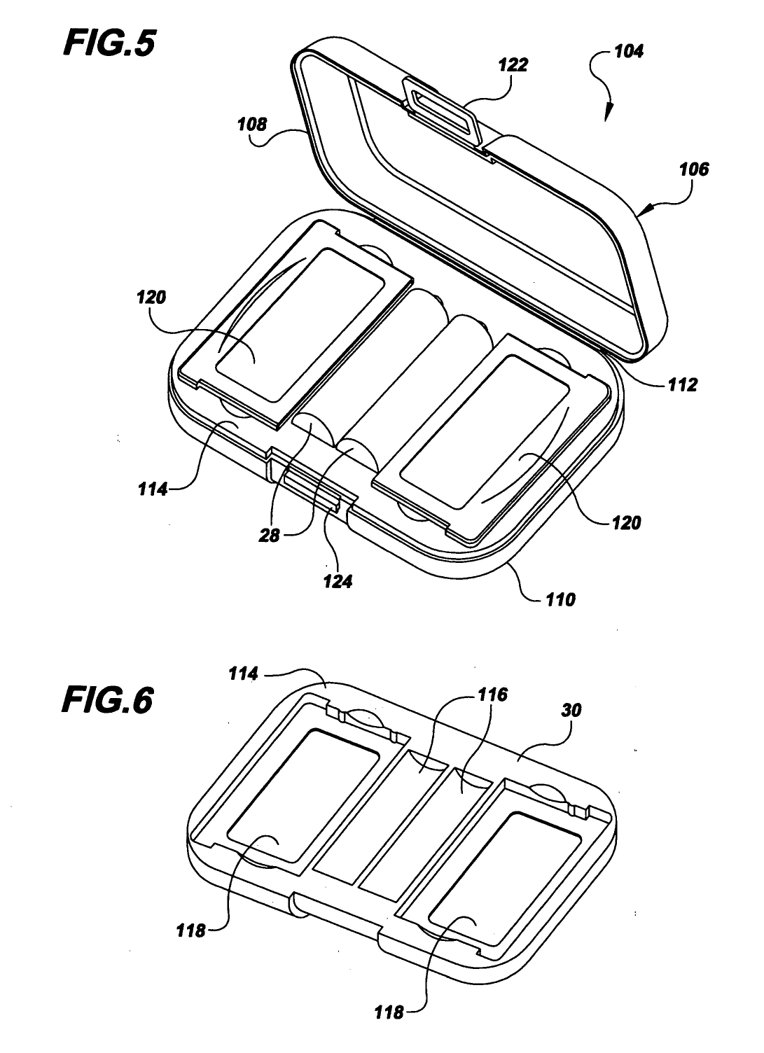

FIG. 5 shows a fifth battery containing pack 104, that includes a fifth light transmitting, rigid exterior shell 106 which may be identical to the first shell 14, and includes a fifth securing half shell 108 and a fifth receiving half shell 110 that may be secured by a hinge 112 to the securing half shell 108, as described above. A fifth resilient insert 114 is shown secured within the fifth receiving half shell 110 in FIG. 5, and is shown alone in FIG. 6, and is dimensioned to be secured within the fifth receiving half shell 110. The fifth resilient insert 114 defines a plurality of fifth cavities 116 dimensioned to receive and secure batteries of one specific size, such as the first size battery 28, e.g., “AA” size batteries. The fifth resilient insert 114 also defines at least one first memory storage device cavity 118 dimensioned to receive and secure memory storage devices of a first size, such as a “video game” memory storage device 120. The fifth resilient insert 114 is also color-coded to be made of or include a specific color that is exclusively associated with a specific battery size. For example, the fifth resilient insert may be made of the first distinctive color 30 that is color-coded to be associated exclusively with the first battery size batteries 28 and the first memory storage device size 120. The fifth rigid, exterior shell 106 of the fifth pack 104 may include as its latch means simply one latch 122 secured to the fifth securing half shell 108 and a corresponding latch receiver 124 secured to the fifth receiving half shell 110 for simplicity of design, or the fifth rigid shell 106 may include the described latch means including a plurality of latches and latch receivers.

The fifth color-coded battery storage pack 104 of the color-coded battery storage system 10 is structured to enhance utility of the system 10 by providing for combined storage of batteries of a size that are coordinated with memory storage devices that are to be utilized in consumer products utilizing the specific battery sizes and memory storage devices common to the consumer products. For example, a popular consumer device is a well known, portable “video game” playing device sold under the trademark “GAMEBOY”, by the Nintendo Company. Those playing devices include memory storage devices of a specific size, such as shown in FIG. 5 at reference number 120, and the playing devices also use “AA”, or the first sized batteries 28. Therefore, an efficient color-coded battery storage pack 104 includes cavities defined to receive both the first size batteries 28 and first size memory storage devices 120, wherein the pack is also color-coordinated with a first color to be exclusively associated with the first size batteries 28 and the first size memory storage device 120. The color-coded battery storage system 10 includes definition of varying sized cavities dimensioned to receive and secure varying memory storage devices (not shown) that are associated with a specific battery size, wherein the specific battery size and specific memory storage device share a unity of utilization within a common consumer device. For example, an additional battery storage pack (not shown) may define cavities dimensioned to receive and secure a battery size utilized in a camera (not shown), and may also define one or more cavities dimensioned to receive and secure a memory storage device utilized in the same camera, such as well known flash memory cards.

The securing half shells 16, 36, 56, 74 and 108 are also cooperatively dimensioned with the resilient inserts 24, 42, 62, 80 and 114 so that whenever the securing half shells are closed over their respective inserts, the securing half shells are positioned adjacent the batteries 28, 46, 66, 84 and memory storage devices 120 to prevent movement of the batteries 28, 46, 66, 84 and memory storage devices 120 out of the resilient inserts 24, 42, 62, 80 and 114 so that the batteries and/or memory storage devices cannot contact each other, even if the packs 12, 32, 52, 70 and 104 were to be dropped or otherwise roughly handled. Such an arrangement further protects the batteries and/or storage devices stored within the color-coded battery storage system. As shown in FIG. 1-5, the packs 12, 32, 52, 70 and 104 are also dimensioned to correspond to a shirt-pocket size, so that they may be readily stored in a user's shirt pocket. For example the exterior dimension of the packs 12, 32, 52, 70 and 104 may be approximately three inches wide by approximately four and one-half inches long, approximately meaning plus or minus twenty percent.

The described embodiments of the color-coded battery storage system 10 include the first through fifth packs 12, 32, 52, 70 and 104 having the disclosed rigid exterior shells 14, 34, 54, 72 and 106 and the resilient inserts 24, 42, 62, 80 and 114 secured within the shells. In a preferred embodiment, the first resilient insert 24 and fifth resilient insert 114 may be made of a yellow, rubber-like material color-coded for the first or “AA” size batteries 28; the second insert 42 may be made of a green, rubber-like material color-coded for the second or “AAA” size batteries 46; the third insert 62 may be made of a orange, rubber-like material color-coded for the third or “123” size batteries 66; and the fourth insert 80 may be made of a purple, rubber-like material color-coded for the fourth or “CR2” size batteries 46. The color-coded battery system 10 includes additional cases (not shown) that may be dimensioned for additional battery sizes having cavities distinctively dimensioned and color-coded for the additional battery sizes.

The color-coded battery storage system 10 has been described in a preferred embodiment as having resilient inserts 24, 42, 62, 80 and 114 that are made of different materials than, and are separable from the rigid exterior shells, 14, 34, 54, 72 and 106. However, it is to be understood that the system 10 also includes an embodiment wherein the first pack 12 includes the plurality of first cavities 26 defined within the first containment chamber 22 of the first light transmitting, rigid shell 14 so that the plurality of first cavities 26 are dimensioned and color-coded for the first size batteries 28, and the second pack 32 includes the plurality of second cavities 44 defined within a second containment chamber 43 of the second light transmitting, rigid shell 34 so that the plurality of second cavities 44 are dimensioned and color-coded for the second sized batteries 46 with a color that is distinct from the color-coding of the first plurality of cavities 26. Such an embodiment of the system 10 may include integrated packs (not shown) wherein the shell and cavities may be manufactured as integrated, single units having distinctive dimensions and color-coding for distinct batteries.

While the present invention has been disclosed with respect to the described and illustrated embodiments of the color-coded battery storage system 10, it is to be understood that the invention is not to be limited to those embodiments. Accordingly, reference should be made primarily to the following claims rather than the foregoing description to determine the scope of the invention.

What is claimed is:

1. A color-coded battery storage system for storing batteries, comprising:
a. a first battery containing pack (12) having a first light transmitting, rigid shell (14) defining a plurality of first cavities (26) within a first containment chamber (22) of the first shell (14), the plurality of first cavities (26) being dimensioned to receive and secure a plurality of a first size batteries (28), and the first cavities (26) being color-coded with a first color (30) exclusively associated with the first size batteries (28); and,
b. a second battery containing pack (32) having a second light transmitting, rigid shell (34) defining a plurality of second cavities (44) within a second containment chamber (43) of the second shell (34), the plurality of second cavities (44) being dimensioned to receive and secure a plurality of second sized batteries (46) distinct from the first sized batteries (28), and the second cavities (44) being color-coded with a second color (48) that is distinct from the first color (30) and that is exclusively associated with the second size batteries (46).

2. The color-coded battery storage system of claim 1, further comprising a first resilient insert (24) secured within a first receiving half shell (18) of the first rigid shell (14), wherein the plurality of first cavities (26) are defined within the first resilient insert (24) and the first resilient insert is color-coded with the first color (30), a second resilient insert (42) secured within a second receiving half shell (38) of the second rigid shell (34), wherein the plurality of second cavities (44) are defined within the second resilient insert (42) and the second resilient insert is color-coded with the second color (48).

3. The color-coded battery storage system of claim 2, wherein the first battery containing pack (12) and second battery containing pack (32) include fluid seal means for restricting movement of fluids into or out of the packs (12) (32) whenever the first rigid shell (14) is closed and whenever the second rigid shell (34) is closed.

4. The color-coded battery storage system of claim 2, wherein the first pack (12) includes a first securing half shell (16) that is dimensioned to be secured adjacent the first sized batteries (28) within the plurality of first sized cavities (26) to secure the first sized batteries (28) against movement out of the cavities (26) whenever the first securing half shell (16) is secured to the first receiving half shell (18) so that the first rigid shell (14) is closed, and the second pack (32) includes a second securing half shell (36) that is dimensioned to be secured adjacent the second sized batteries (46) within the plurality of second sized cavities (44) to secure the second sized batteries (46) against movement out of the cavities (44) whenever the second securing half shell (36) is secured to the second receiving half shell (38) so that the second rigid shell (34) is closed.

5. The color-coded battery storage system of claim 1, wherein the first containment chamber (22) also defines at least one first memory device cavity (118) dimensioned to receive and secure a first size memory storage device (120) so that the first color (30) of the plurality of first cavities (26) is exclusively associated with the first size batteries (28) and with the first size memory storage device (120).

6. The color-coded battery storage system of claim 1, further comprising a third battery containing pack (52) having a third light transmitting, rigid shell (54) and defining a plurality of third cavities (64) being dimensioned to receive and secure a plurality of third sized batteries (66) distinct from the first sized batteries (28) and distinct from the second sized batteries (46), and the third cavities (64) being color-coded with a third color (68) that is distinct from the first color (30), that is distinct from the second color (48), and wherein the third color (68) is exclusively associated with the third size batteries (66).

7. The color-coded battery storage system of claim 6, further comprising a fourth battery containing pack (70) having a fourth light transmitting, rigid shell (72) and defining a plurality of fourth cavities (82) being dimensioned to receive and secure a plurality of fourth sized batteries (84) distinct from the first sized batteries (28), distinct from the second sized batteries (46), and distinct from the third sized batteries (66), and the fourth cavities (82) being color-coded with a fourth color (86) that is distinct from the first color (30), that is distinct from the second color (48), that is distinct from the third color (68), and wherein the fourth color (86) is exclusively associated with the fourth size batteries (84).

8. The color-coded battery storage system of claim 1, wherein the first battery containing pack (12) and the second battery containing pack (32) are each dimensioned to be a shirt-pocket size of approximately three inches wide and approximately four and one-half inches long.
